(19) United States
(12) Patent Application Publication
(10) Pub. No.: US 2008/0145121 A1
(43) Pub. Date: Jun. 19, 2008

(54) IMAGE FORMING APPARATUS

(75) Inventor: Dong Hyun YOO, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/777,497

(22) Filed: Jul. 13, 2007

(30) Foreign Application Priority Data
Dec. 15, 2006 (KR) 2006-128365

(51) Int. Cl. G03G 15/00

(52) U.S. Cl. 399/367

(57) ABSTRACT

An image forming apparatus which has an improved structure capable of decreasing the size of a scanning part. The image forming apparatus includes an automatic document feeder (ADF), a flat glass, an ADF glass to scan a document fed by the ADF, and an image sensor to read information from the document. The ADF glass can be mounted at an angle with respect to the flat glass. The image sensor can be rotated from a position in parallel with the flat glass to a position in parallel with the ADF glass and vice versa by an image sensor rotating device.

### CROSS-REFERENCE TO RELATED APPLICATIONS

This application claims the benefit of Korean Patent Application No. 2006-0128365, filed on Dec. 15, 2006 in the Korean Intellectual Property Office, the disclosure of which is incorporated herein by reference.

### BACKGROUND OF THE INVENTION

1. Field of the Invention

The present general inventive concept relates to an image forming apparatus, and more particularly, to an image forming apparatus which is equipped with an automatic document feeder to provide successive scanning.

2. Description of the Related Art

Generally, an image forming apparatus is an apparatus that prints an image on a medium to be printed according to an inputted image signal. An image forming apparatus is classified as a printer, a copying machine, or a multi-function printer which has multiple functions of printing, copying and scanning, and the like. A multi-function printer includes a scanning part which reads an image recorded on an original document through a reading unit, and a printing part which prints the image on paper.

In order that the scanning part reads information from the original document, it is necessary to move the reading unit or to move the original document. A type of moving the reading unit while fixing the original document is called a “flat bed type,” and a type of moving the original document while keeping the reading unit fixed is called a “sheet feed type.” A recently-developed multi-function printer adopts both types described above, an example of which is disclosed in Korean Patent Registration No. 555716.

The disclosed image forming apparatus is provided with an automatic document feeder (ADF) which is mounted to an upper portion of a main body, so as to successively scan the original documents by automatically supplying the same. An ADF glass for successive scanning and a flat glass for individual scanning are mounted to the upper portion of the main body. Reading units are respectively mounted under the ADF glass and the flat glass to read the information from the original documents. Therefore, one reading unit moves along the flat glass and scans the individual original document loaded on the flat glass. Also, the other reading unit successively scans the documents which are fed by the ADF while it is kept in a stationary state. In the scanning using the ADF, the documents to be scanned are loaded on a document supply tray provided at the upper portion of the main body. The documents are fed into the main body sheet by sheet by the ADF, and scanned by the reading unit provided under the ADF glass. And, the scanned documents are discharged to a document discharge tray provided under the document supply tray.

However, because the conventional image forming apparatus has a structure in which the documents loaded on the document supply tray are discharged to the document discharge tray provided at the upper portion of the main body via a C-shaped path formed inside the ADF, it creates the problem that the size of the image forming apparatus becomes large and the upper portion of the image forming apparatus, in which the scanning part is provided, has asymmetrical shapes. Due to the C-shaped path formed inside the ADF, the size of the ADF is subjected to be increased, and the ADF-mounted portion of the image forming apparatus protrudes upward.

The upwardly-protruding ADF causes the increase in size of the image forming apparatus, and as a result causes the increase of the height of a packaging box containing the image forming apparatus. Accordingly, the packing efficiency is decreased, and the apparatus may be easily damaged by external shock during the product distribution.

### SUMMARY OF THE INVENTION

The present general inventive concept provides an image forming apparatus which has an improved structure capable of decreasing the size of a scanning part.

Additional aspects and/or advantages of the invention will be set forth in part in the description which follows and, in part, will be obvious from the description, or may be learned by practice of the invention.

The foregoing and/or other aspects and utilities of the present general inventive concept may be achieved by providing an image forming apparatus having an automatic document feeder (ADF) to provide successive scanning, including: a main body including an image forming part; a flat glass provided at the main body; an ADF glass to scan a document fed by the ADF; an image sensor reading information from the document; and an image sensor rotating device to rotate the image sensor between a first position adequate to scan using the flat glass and a second position adequate to scan using the ADF glass.

The ADF glass can be mounted at an angle with respect to the flat glass.

The ADF can include a document feeding path which is defined between a document introduction port formed at a top portion of the main body and a document discharge port formed at a side portion of the main body.

The image sensor rotating device can include a guide part which is provided at the image sensor and a rotating gear which has a holding part to restrain the guide part when the image sensor is rotating.

The image sensor rotating device can further include a driving part to drive the rotating gear. The driving part may include a motor or a rack.

The image forming apparatus can further include a cover which is coupled with a hinge to the main body to open and shield the flat glass, and a document supply tray which is coupled with a hinge to the cover.

The image forming apparatus can further include a document discharge tray which is provided with a hinge below the document discharge port.

The ADF can further include a white roller which pressurizes the document passing through the document feeding path to the ADF glass.

The foregoing and/or other aspects and utilities of the present general inventive concept can also be achieved by providing an image forming apparatus including a scanning part having an automatic document feeder (ADF) to provide successive scanning, including: a main body including an image forming part; a flat glass provided at the main body; and an image sensor to read an image from a document. The scanning part can include a document feeding path which is provided at an angle from a top portion of the main body to a side portion of the main body, and an ADF glass which is provided on the document feeding path.

The scanning part can further include an image sensor rotating device to rotate the image sensor from a position in parallel with the flat glass to a position in parallel with the ADF glass and vice versa.

The foregoing and/or other aspects and utilities of the present general inventive concept can also be achieved by providing an automatic document feeder (ADF) apparatus, including a placement glass to hold a document in place to be scanned, an ADF glass to scan a document fed by the ADF, and a rotatable image sensor to rotate between a first position to move along the placement glass to scan the document placed thereon and a second position to face the ADF glass to scan the document fed along the ADF glass.

The ADF glass can be mounted at a predetermined angle with respect to the placement glass.

The ADF apparatus may further include a first guide channel to guide the image sensor along a plane parallel with the placement glass to read the document placed thereon and a second guide channel to guide the image sensor along an arc to face the ADF glass to read the document being moved along the ADF glass.

The ADF apparatus may further include an image sensor rotating part to rotate the image sensor between the first position and the second position. The image sensor rotating part may include a rotating gear assembly to engage and rotate the image sensor along the second guide channel from the first guide channel to read a document moving along the ADF glass and to rotate the image sensor to the first guide path from the second guide path and disengage the image sensor to read a document placed on the placement glass.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a sectional view illustrating a constitution of an image forming apparatus in accordance with an embodiment of the present general inventive concept;

FIG. 2 is an enlarged view of an “A” portion in FIG. 1;

FIG. 3 is a perspective view illustrating an image sensor, an image sensor rotating device, and a guide structure to guide movement of an image sensor of the image forming apparatus in accordance with an embodiment of the present general inventive concept;

FIGS. 4 and 5 are sectional views illustrating operation of an image sensor of the image forming apparatus in accordance with an embodiment of the present general inventive concept; and

FIG. 6 is a sectional view illustrating a modified embodiment of a driving part of an image forming apparatus in accordance with an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

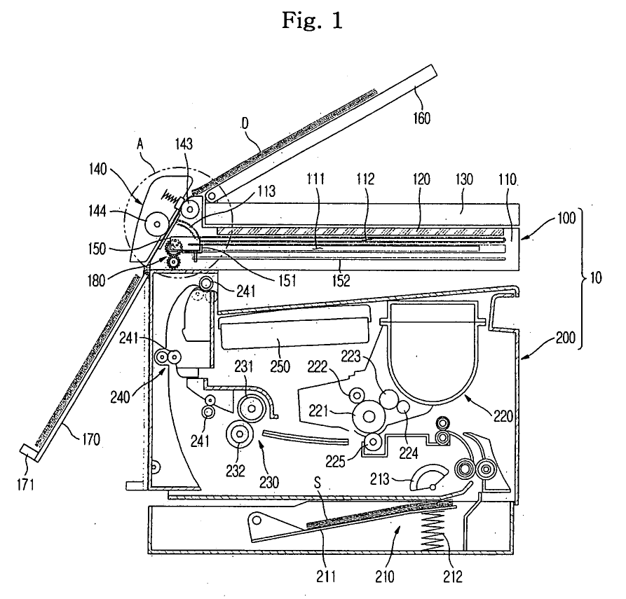

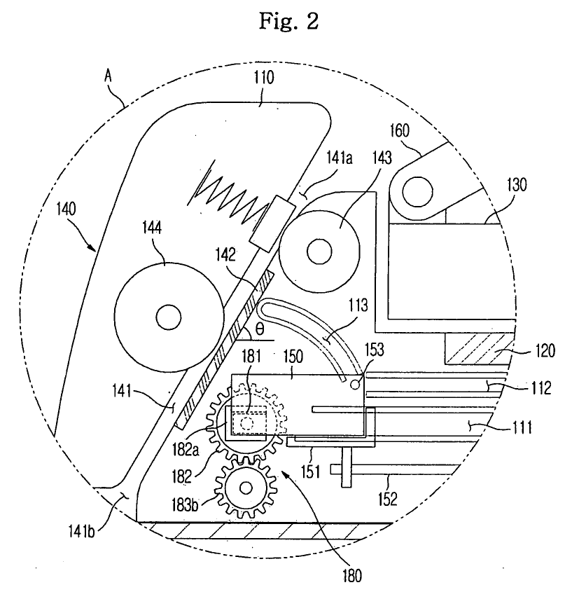

FIG. 1 is a sectional view illustrating an image forming apparatus in accordance with an embodiment of the present general inventive concept, and FIG. 2 is an enlarged view of an “A” portion in FIG. 1.

As illustrated in FIG. 1, an image forming apparatus according to an embodiment of the present general inventive concept comprises a main body 10 including a scanning part 100 which reads an image from an original document and an image forming part 200 which prints the image on a paper. Components constituting the scanning part 100 are installed at an upper portion of the main body 10, and components constituting the image forming part 200 are installed under the scanning part 100.

The image forming part 200 prints the image in response to a signal from the scanning part 100 or a signal from an external apparatus, such as a computer, etc. The image forming part 200 includes a paper feeding unit 210 to supply a medium to be printed, e.g., a paper S, a developing unit 220 to develope the image on the paper, a fixing unit 230 to fix the developed image to the paper by applying heat and pressure to the paper, and a discharge unit 240 to discharge the printed paper out of the main body 10.

The paper feeding unit 210 includes a paper feeding tray 211 on which the paper S is loaded, and a spring 212 which elastically supports the paper feeding tray 211. The paper loaded on the paper feeding tray 211 is picked up sheet by sheet by a pickup roller 213 and fed toward the developing unit 220.

The developing unit 220 includes a photosensitive drum 221 on which an electrostatic latent image is formed by a laser scanning unit 250, a charge roller 222 which charges the photosensitive drum 221, a developing roller 223 which develops the electrostatic latent image on the photosensitive drum 221 to a toner image, a toner supply roller 224 which supplies toner to the developing roller 223, and a transfer roller 225 which pressurizes the paper toward the photosensitive drum 221 to transfer the toner image developed on the photosensitive drum 221 to the paper.

The fixing unit 230 includes a heat roller 231 which has a heat source to heat the toner image transferred to the paper, and a press roller 232 which is disposed opposite to the heat roller 231 and maintains the constant fixing pressure with the heat roller 231.

The discharge unit 240 includes discharge rollers 241 which are sequentially mounted so as to discharge the paper having passed through the fixing unit 230 out of the main body 10.

The scanning part 100 includes a scanning frame 110 which houses the components constituting the scanning part 100, a flat glass 120 which is provided at a top of the scanning frame 110 so that a user can put the original document thereon sheet by sheet, a cover 130 which is coupled with a hinge to the scanning frame 110 to open and shield the flat glass 120, an automatic document feeder (ADF) 140 which automatically feeds the original documents to provide successive scanning, and an image sensor 150 which reads the image from the original documents.

As illustrated in FIGS. 1 and 2, the ADF 140 includes a document feeding path 141 which is formed at an angle downward from a top portion of the scanning frame 110 to a bottom (or side) portion of the scanning frame 110, and an ADF glass 142 which is provided on the document feeding path 141. The ADF glass 142 is provided on the slanted (angled downward) document feeding path 141, while the flat glass 120 is horizontally mounted to the top of the scanning frame 110. Thus, the ADF glass 142 is mounted at a predetermined angle e with respect to the flat glass 120.

A document introduction port 141a, through which the document is introduced into the document feeding path 141, is formed at the top portion of the scanning frame 110, and a document discharge port 141b, through which the scanned document is discharged from the document feeding path 141, is formed at the bottom (or side) portion of the scanning frame 110. A document supply tray 160, on which the original documents are loaded, is provided near the document introduction port 141 a. The original documents loaded on the document supply tray 160 are fed by the ADF 140. The document supply tray 160 is coupled with a hinge to the cover 130. When the original documents are scanned using the ADF 140, the document supply tray 160 is pivoted upward by a preset angle, and the documents D are loaded on the document supply tray 160. A document discharge tray 170 is provided below the document discharge port 141b, on which the scanned documents are collected. One end of the document discharge tray 170 is coupled with a hinge to the main body 10, and the other end of the document discharge tray 170 is formed with a support part 171 which supports the documents moving downward from the document feeding path 141.

The image sensor 150 is disposed under the flat glass 120 and the ADF glass 142, and reads the image information from the original document which is put on the flat glass 120 or fed by the ADF 140. The image sensor 150 irradiates light to the original document and detects the light reflected from the original document. By converting the light intensity into an electric signal, the image sensor 150 can read the image information from the original document. The image sensor 150 may be configured as a contact image sensor (CIS) or a charge coupled device (CCD).

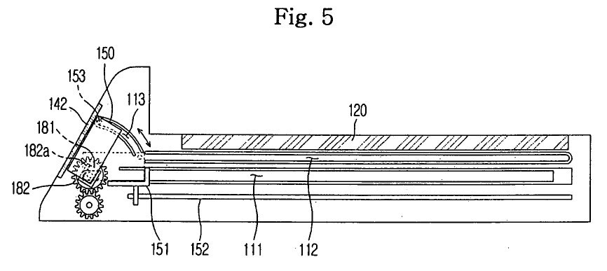

The simplification of the structure of the document feeding path results in a decrease in size of the ADF. However, the position of the image sensor 150 adequate to provide scanning using the flat glass 120 (hereinafter, referred to as a “first position”) differs from the position of the image sensor 150 adequate to provide scanning using the ADF glass 142 (hereinafter, referred to as a “second position”). As illustrated by a dotted line in FIG. 5, when the image sensor 150 is disposed in parallel with the flat glass 120, it is adequate to provide scanning using the flat glass 120, but is not adequate to provide scanning using the ADF glass 142. On the other hand, as illustrated by a real line in FIG. 5, when the image sensor 150 is disposed in parallel with the ADF glass 142, it is adequate to provide the scanning using the ADF glass 142, but is not adequate to provide the scanning using the flat glass 120.

Accordingly, the image forming apparatus according to embodiments of the present general inventive concept can be provided with an image sensor rotating device 180 to rotate the image sensor 150 from first position to a second position, and vice versa. When scanning a document loaded on the flat glass 120, the image sensor 150 positioned at the first position moves linearly along the flat glass 120 to read the information from the document. When scanning the document supplied by the ADF 140, the image sensor 150 is rotated from the first position toward the ADF glass 142 by the image sensor rotating device 180 and is then located at the second position. While remaining at the second position, the image sensor 150 can read the information from the document passing through the document feeding path 141.

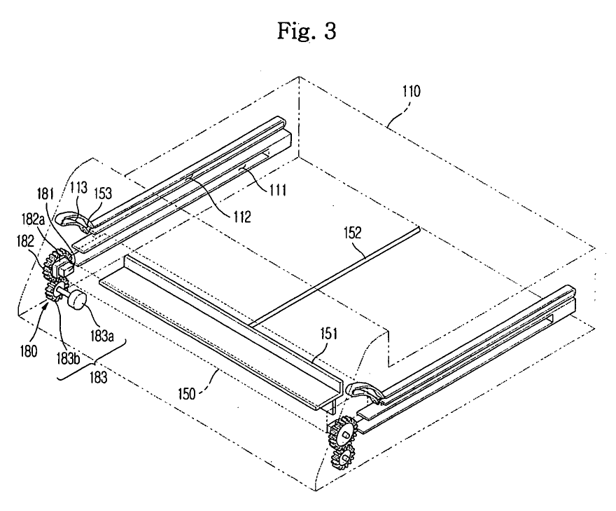

FIG. 3 is a perspective view illustrating the image sensor 150, the image sensor rotating device 180, and a guide structure to guide movement of the image sensor 150.

As illustrated in FIGS. 2 and 3, an image sensor carrier 151 on which the image sensor 150 is loaded, a driving device (not illustrated) for linearly reciprocating the image sensor carrier 151, and a guide shaft 152 to guide the linear movement of the image sensor carrier 151 are mounted inside the scanning frame 110. The driving device drives the image sensor carrier 151 when scanning the document using the flat glass 120, which includes a motor, a belt, a pulley, etc. Because such a driving device is already well known, a detailed explanation thereof will be omitted.

The image sensor rotating device 180 includes a guide part 181 which is provided at a side surface of the image sensor 150, a rotating gear 182 which has a holding part 182a to restrain the guide part 181 during the rotation of the image sensor 150, and a driving part 183 which rotates the rotating gear 182.

The rotating gear 182 is mounted to an inner surface of the scanning frame 110 at a position opposite to the guide part 181 of the image sensor 150. The holding part 182a of the rotating gear 182 has an opened portion so that when scanning a document loaded on the flat glass 120, the guide part 181 of the image sensor 150 is separated from the holding part 182a to allow the image sensor 150 to move linearly. When the image sensor 150 reciprocates linearly, the guide part 181 of the image sensor 150 is guided by a first guide channel 111 formed at the scanning frame 110.

The driving part 183 includes a motor 183a which supplies power to rotate the image sensor 150, and a power transmission gear 183b which transmits power from the motor 183a to the rotating gear 182. The motor 183a may be structured to rotate only the image sensor 150. Alternatively, the motor 183a may be structured to drive other components of the scanning part 100 as well as the image sensor 150.

Also, a guide protrusion 153 is formed at a side surface of the image sensor 150. When the image sensor 150 moves linearly, the guide protrusion 153 is guided by a second guide channel 112 formed above the first guide channel 111. The guide protrusion 153 is also guided by an arc-shaped third guide channel 113 provided inside the scanning frame 110, when the image sensor 150 is rotated.

As illustrated in FIG. 2, the ADF 140 includes a document pickup roller 143 which picks up the document D sheet by sheet, and a white roller 144 which is disposed opposite to the ADF glass 142 to maintain a feeding speed and a pressure constantly when scanning the picked-up document.

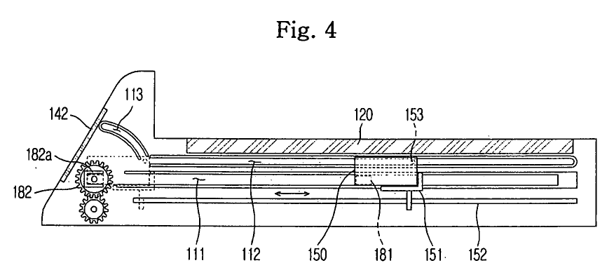

Hereinafter, operation of the image forming apparatus described above will be described with reference to FIGS. 1, 4 and 5. FIG. 4 is a sectional view illustrating an operational state when the image sensor 150 scans a document loaded on the flat glass, and FIG. 5 is a sectional view illustrating an operational state when the image sensor 150 scans the document passing by the ADF glass 142.

As illustrated in FIG. 4, when scanning a document D loaded on the flat glass 120, the image sensor 150 when located at the first position moves linearly along the flat glass 120 and reads the information from the document D.

As illustrated in FIG. 5, when scanning a document D fed by the ADF 140, the image sensor 150 is rotated from the first position to the second position by the image sensor rotating device 180. The image sensor 150 approaches the ADF glass 142 to be parallel therewith and reads the information from the document passing by the ADF glass 142.

If a command to print the scanned information is generated or a printing command is generated from an external computer, a printing paper S loaded on the paper feeding tray 211 is picked up by the pickup roller 213 and fed along the predetermined route. An image is printed on the paper while the paper passes through the developing unit 220 and the fixing unit 230, and the printed paper having passed through the fixing unit 230 is discharged out of the main body 10 by the discharge rollers 241.

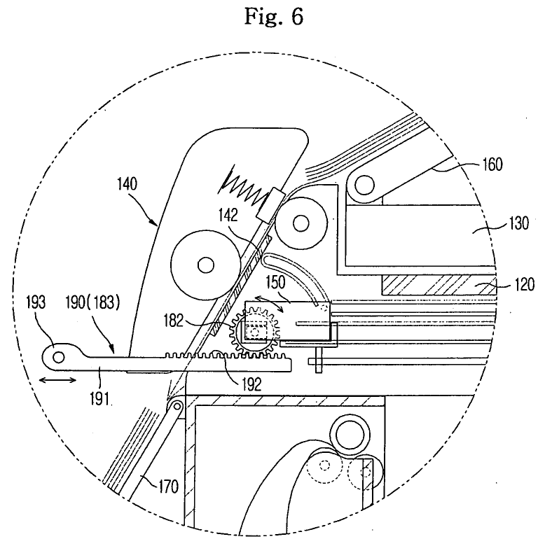

FIG. 6 is a sectional view illustrating another embodiment of a driving part of an image forming apparatus. Only the features of this embodiment over the previous embodiment will be described. The same elements as the previous embodiment illustrated in FIG. 1 are denoted by the same reference numerals.

As illustrated in FIG. 6, the driving part to drive the rotating gear 182 of the image sensor rotating device 180 may be configured as a rack 190. The rack 190 includes a bar-shaped body 191, teeth 192 which are formed at a surface of the body 191 to engage with the rotating gear 182, and a knob 193 which is formed at an end portion of the body 191 extending outside of the scanning frame 110. The image sensor 150 can be rotated by the rack 190 without an electromotive driving unit, such as a motor, in such a manner that a user grasps the knob 193 and pulls or pushes the rack 190 to rotate the image sensor 150, thereby simplifying the operation.

As apparent from the above description, the image forming apparatus according to various embodiments of the present general inventive concept are constituted such that the document feeding path formed in the ADF is simplified and the scanning using the flat glass and the ADF glass can be achieved with one image sensor. Accordingly, the scanning part becomes compact.

Also, the scanning part has an overall balanced shape without an especially protruding portion in a particular direction. Accordingly, the packing and the distribution of the products can be achieved efficiently.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image forming apparatus having an automatic document feeder (ADF) to provide successive scanning, comprising:
a main body including an image forming part;
a flat glass provided at the main body;
an ADF glass to scan a document fed by the ADF;
an image sensor to read information from a document; and
an image sensor rotating device to rotate the image sensor between a first position adequate to scan using the flat glass and a second position adequate to scan using the ADF glass.

2. The image forming apparatus according to claim 1, wherein the ADF glass is mounted at an angle with respect to the flat glass.

3. The image forming apparatus according to claim 1, wherein the ADF includes a document feeding path which is defined between a document introduction port formed at a top portion of the main body and a document discharge port formed at a side portion of the main body.

4. The image forming apparatus according to claim 1, wherein the image sensor rotating device includes a guide part which is provided at the image sensor and a rotating gear which has a holding part to restrain the guide part during the rotation of the image sensor.

5. The image forming apparatus according to claim 4, wherein the image sensor rotating device further includes a driving part to drive the rotating gear.

6. The image forming apparatus according to claim 5, wherein the driving part includes a motor.

7. The image forming apparatus according to claim 5, wherein the driving part includes a rack.

8. The image forming apparatus according to claim 1, further comprising:
a cover which is coupled with a hinge to the main body to open and shield the flat glass; and
a document supply tray which is coupled with a hinge to the cover.

9. The image forming apparatus according to claim 3, further comprising:
a document discharge tray which is provided with a hinge below the document discharge port.

10. The image forming apparatus according to claim 3, wherein the ADF further includes a white roller which pressurizes the document passing through the document feeding path to the ADF glass.

11. An image forming apparatus including a scanning part having an automatic document feeder (ADF) to provide successive scanning, comprising:
a main body including an image forming part;
a flat glass provided at the main body; and
an image sensor to read an image from a document,
wherein the scanning part includes a document feeding path which is provided at an angle from a top portion of the main body to a side portion of the main body, and an ADF glass which is provided on the document feeding path.

12. The image forming apparatus according to claim 11, wherein the scanning part further includes an image sensor rotating device to rotate the image sensor from a position in parallel with the flat glass to a position in parallel with the ADF glass and vice versa.

13. The image forming apparatus according to claim 12, wherein the image sensor rotating device includes a guide part which is provided at the image sensor and a rotating gear which has a holding part to restrain the guide part during the rotation of the image sensor.

14. The image forming apparatus according to claim 13, wherein the image sensor rotating device further includes a driving part to drive the rotating gear.

15. The image forming apparatus according to claim 11, further comprising:
a cover coupled with a hinge to the main body to open and shield the flat glass; and
a document supply tray coupled with a hinge to the cover, on which a document to be supplied into the document feeding path is loaded.

16. The image forming apparatus according to claim 11, further comprising:
a document discharge tray which is coupled with a hinge to the main body under the document feeding path.

17. An automatic document feeder (ADF) apparatus, comprising:
a placement glass to hold a document in place to be scanned;
an ADF glass to scan a document fed by the ADF; and
a rotatable image sensor to rotate between a first position to move along the placement glass to scan the document placed thereon and a second position to face the ADF glass to scan the document fed along the ADF glass.

18. The ADF apparatus according to claim 17, wherein the ADF glass is mounted at a predetermined angle with respect to the placement glass.

19. The ADF apparatus according to claim 17, further comprising:
a first guide channel to guide the image sensor along a plane parallel with the placement glass to read the document placed thereon; and
a second guide channel to guide the image sensor along an arc to face the ADF glass to read the document being moved along the ADF glass.

20. The ADF apparatus according to claim 19, further comprising:
an image sensor rotating part to rotate the image sensor between the first position and the second position.

21. The ADF apparatus according to claim 20, wherein the image sensor rotating part comprises:
a rotating gear assembly to engage and rotate the image sensor along the second guide channel from the first guide channel to read a document moving along the ADF glass and to rotate the image sensor to the first guide path from the second guide path and disengage the image sensor to read a document placed on the placement glass.
